(19) United States
(12) Patent Application Publication
(10) Pub. No.: US 2014/0078378 A1
(43) Pub. Date: Mar. 20, 2014

(54) Active Imaging Device Having Field of View and Field of Illumination With Corresponding Rectangular Aspect Ratios

(71) Applicants: Louis Demers, Saint-Romulad (Quebec) (CA); Jacques Godin, Quebec (Quebec) (CA); Martin Grenier, Quebec (Quebec) (CA)

(72) Inventors: Louis Demers, Saint-Romulad (Quebec) (CA); Jacques Godin, Quebec (Quebec) (CA); Martin Grenier, Quebec (Quebec) (CA)

(73) Assignee: Obzerv Technologies Unc., Quebec (Quebec) (CA)

(21) Appl. No.: 14/118,525

(22) PCT Filed: May 24, 2012
(86) PCT No.: PCT/CA2012/050341

§ 371 Date: Nov. 18, 2013

Related U.S. Application Data
(60) Provisional application No. 61/489,881, filed on May 25, 2011.

(51) Int. Cl. H04N 5/225

(52) U.S. Cl. CPC H04N 5/2256; H04N 5/2254
USPC 348/359

(57) ABSTRACT

Active imaging devices can include a camera and an illuminator that provides light to the scene under observation. Most often, a laser beam combined with projector optics is used to generate a field of illumination while a telescope and a camera are use to acquire the images in its field of view. This specification demonstrates the production of a rectangular field of illumination having a highly uniform intensity distribution matching and aligned with a rectangular field of view of the camera.

### BACKGROUND

Active imaging devices have both a camera and an integrated light source to illuminate the scene under observation. They can thus be said to include both an emission and reception channel. The emission channel typically uses an illuminator and its associated projection optics to produce, in the far field, a field of illumination (FOI). The reception channel typically uses a camera sensor and its associated reception optics (e.g. a telescope) giving a field of view (FOV). Active imaging devices typically offer independent control over the FOI and FOV by controlling the dedicated projection and reception optics.

Given the format of camera sensors, the camera aspect ratio is typically rectangular and the camera sensor typically has a uniform sensitivity across its surface area. However, previously known illuminators were non-rectangular and many even had non-uniform intensity distribution. For instance, typical micro-collimated laser diode arrays illuminators coupled to a projector produce, in the far field, a field of illumination having a Gaussian-like intensity distribution. An example of such a non-uniform and non-rectangular field of illumination 110 is shown in FIG. 1A on which a typical camera field of view 112 is superimposed. An exemplary intensity distribution is illustrated at FIG. 1B in which the Y-axis represents the relative intensity and the X-axis represents the horizontal angular position.

From FIG. 1A, it will be understood that a portion of the field of illumination exceeds the field of view and is thus of no use to the camera sensor. In covert applications, the excess illumination reduces the stealthiness of the imaging device by allowing its detection from outside its field of view. Further, in the case of active imaging devices used with limited energy sources, the excess illumination represents undesirably wasted energy. From FIG. 1B, it will be understood that the intensity distribution further did not match the sensitivity distribution of the camera sensor. There thus remained room for improvement.

### SUMMARY

It was found that the field of illumination could be matched to the field of view by using a fiber illuminator having an illumination area with a rectangular cross-sectional shape that matches the aspect ratio of the sensor, and consequent field of view of the camera.

In accordance with one aspect, there is provided an active imaging device having: a fiber illuminator having a rectangular illumination area; a projector lens group having a focal plane coupleable to the rectangular illumination area to project a corresponding rectangular field of illumination on a scene located at far field of the projector lens group, a camera having a camera sensor and a rectangular field of view alignable with the rectangular field of illumination, the field of view and the field of illumination having matching rectangular aspect ratios.

In accordance with another aspect, there is provided an active imaging device having: a frame; a camera mounted to the frame, having a camera sensor, and a field of view having a camera aspect ratio; a fiber illuminator mounted to the frame and having a rectangular cross-section light output path corresponding to the camera aspect ratio; and a projector lens group mounted to the frame, the projector lens group being optically coupleable to the light output path of the fiber illuminator for projection into a field of illumination aligned with the field of view of the camera.

In accordance with another aspect, there is provided an active imaging device having: a frame; a telescope mounted to the frame, a camera mounted to the frame, having a sensor, and a field of view having a rectangular aspect ratio; a fiber illuminator mounted to the frame and having a rectangular cross-section corresponding to the camera aspect ratio; and a projector lens group mounted to the frame, the projector lens group being optically coupled to the output of the fiber illuminator projecting a field of illumination corresponding to the field of view of the camera.

Many further features and combinations thereof concerning the present improvements will appear to those skilled in the art following a reading of the instant disclosure.

### DESCRIPTION OF THE FIGURES

In the figures,

FIG. 1A shows a field of illumination overlapped by a field of view, in accordance with the prior art, FIG. 1B showing an intensity distribution thereof;

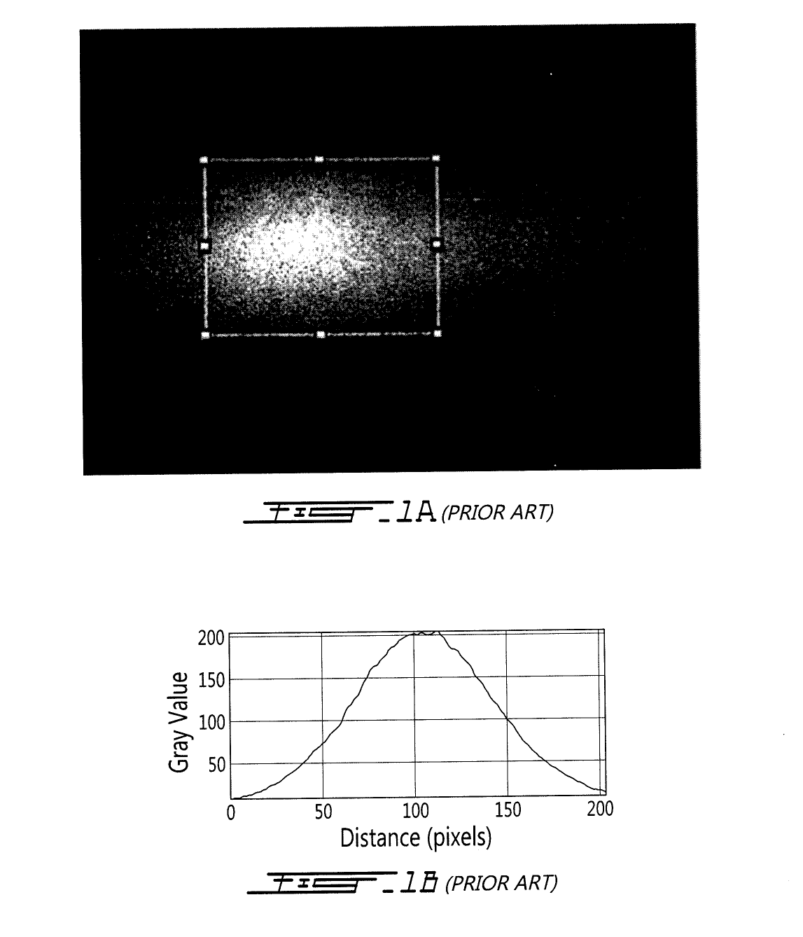

FIGS. 2A and 2B schematically demonstrate corresponding imperfect matches between circular field of illumination and a rectangular field of view;

FIG. 3 shows an example of an active imaging device having a field of illumination and a field of view with matching aspect ratios;

FIG. 4 shows a field of illumination of the active imaging device of FIG. 3;

FIG. 5A to 5D show several fiber illuminator embodiments for the active imaging device of FIG. 3; and

FIG. 6 shows a variant to the active imaging device of FIG. 3.

### DETAILED DESCRIPTION

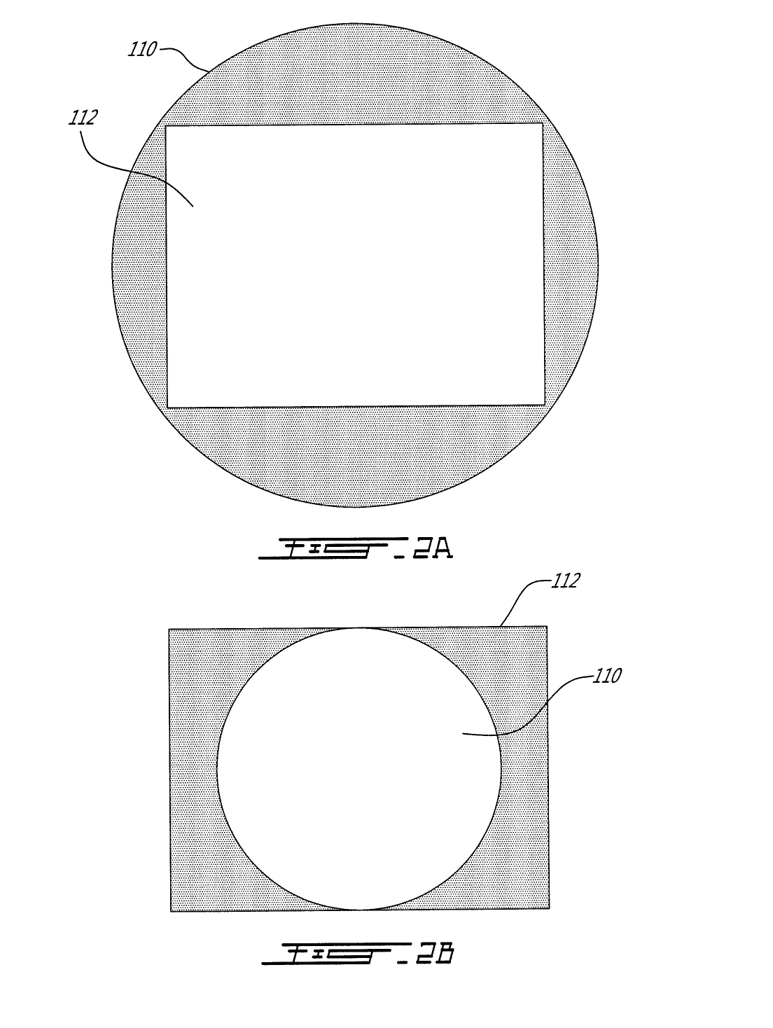

A circular field of illumination can be produced by a light source coupled to a circular core optical fiber which, in turn, is injected into projection optics. However, as demonstrated on FIG. 2A, the intersection area between a circular field of illumination 110 and a typical rectangular 4:3 aspect ratio FOV 112 will yield only 58% of surface overlap. Alternatively, as shown in FIG. 2B, if the circular FOI 110 is made smaller to fit inside the FOV 112, then part of the FOV 112 becomes completely dark and unusable. This is solely based on geometrical considerations.

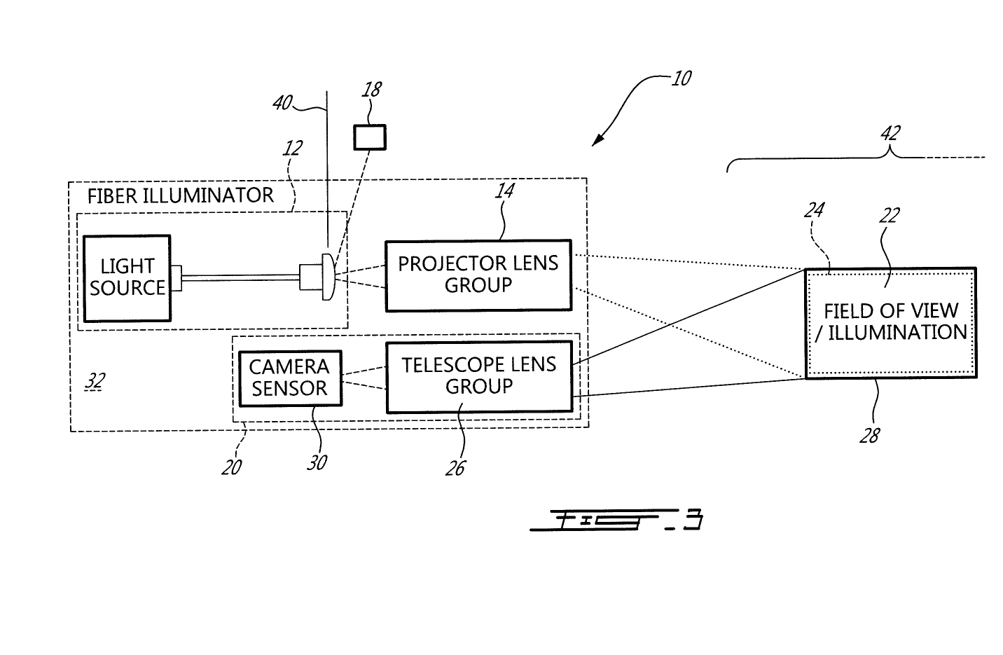

In FIG. 3, an active imaging device 10 is shown having a fiber illuminator 12 having an illumination area 18 schematically depicted as having a rectangular aspect ratio. The active imaging device 10 further has a camera 20 having a field of view 22 with a rectangular aspect ratio, and a projector lens group 14 having a focal plane 40 coupled to the rectangular illumination area 18, in the sense that the rectangular illumination area 18 is positioned at the focal plane 40 of the projector lens group 14 for the projector lens group to produce, in the far field 42, a field of illumination 24 having an aspect ratio corresponding to the aspect ratio of the field of view 22 of the camera 20. Examples of how such a rectangular shape 18 can be obtained from a fiber illuminator 12 will be described below.

The projector lens group 14 can include a tiltable alignment lens group for instance, to align the optical axis of the fiber illuminator 12 with the optical axis of the projector lens group 14. The field of illumination 24 can then be boresighted with the field of view 22 by the use of Risley prisms used at the output of the projector lens group 14 or by mechanically steering the coupled fiber illuminator 12 and projector lens group 14 assembly, for instance. The projector lens group 14 projects, on a scene 28 located in the far field 42, the rectangular image of the rectangular illumination area 18.

Light is reflected by the scene 28. In this embodiment, the reception channel has a camera 20 which includes both a telescope lens group 26 and camera sensor 30 positioned at a focal plane of the telescope lens group 26. The camera 20 can thus have a field of view 22 with a rectangular aspect ratio which matches the rectangular aspect ratio of the field of illumination 24 and thus receive the reflected light with the camera sensor 30. The divergence of the illumination can be adjusted using the projector lens group 14 to scale the rectangular field of illumination 24 with the field of view 22, for instance. The field of view 22 of the camera 30 can thus be fully illuminated by a field of illumination 24 which does not, at least significantly, extend past the field of view 22. In practice, the fiber illuminator 12, camera sensor 30, and the optical components 14, 26 can all be mounted on a common frame 32 to restrict relative movement therebetween. The illumination channel and reception channel can be provided in a common housing, or in separate housings and be independently steered towards the same point under observation, for instance.

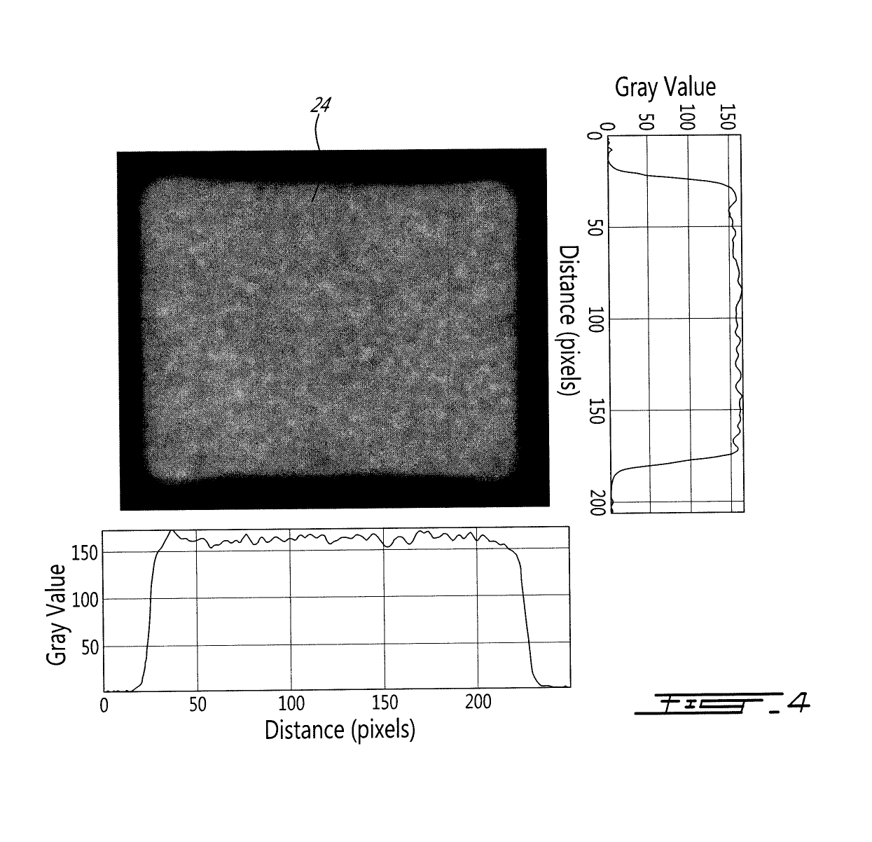

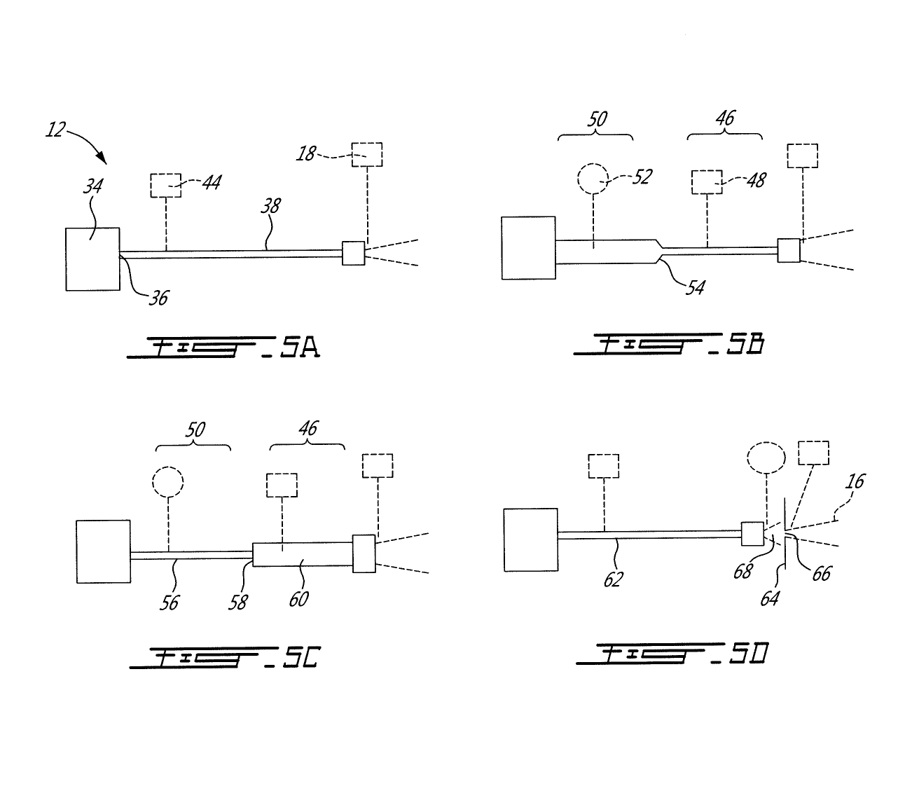

An example of a rectangular field of illumination 24, in the far field, is shown more clearly in FIG. 4. This rectangular shape was obtained using a fiber illuminator 12 as shown in FIG. 5A, having a light source 34, such as a laser, a LED or another convenient source, optically coupled to the input end 36 of a highly multimode optical fiber 38 having a rectangular core 44. As shown schematically in FIG. 5A, the rectangular core 44 reaches the output end where it generates a rectangular illumination area 18 which can have the same shape and aspect ratio as the rectangular aspect ratio of the camera sensor 30. The cladding of the optical fiber 38 can be circular, in which case the optical fiber 38 can be drawn from a corresponding preform for instance. Alternately, the cladding of the optical fiber 38 can have another shape, such as rectangular for example and be either drawn from a corresponding preform, or be pressed into shape subsequently to drawing, such as by compressing an optical fiber between flat plates and subjecting to heat for instance.

In alternate fiber illuminator embodiment schematized at FIG. 5B, an output section 46 of an optical fiber has been shaped into a rectangular cross-section 48 by compressing and subjecting to heat, thereby shaping the core into a rectangular cross-section leading to a rectangular illumination area. An input section 50 of the optical fiber was left in its original circular shape 52. A tapering section 54 can bridge both sections progressively, for instance. The input section 50 is optional.

An other alternate fiber illuminator embodiment is schematized at FIG. 5C, having a circular cross-section optical fiber 56 forming an input section 50 fusion spliced 58 to a rectangular cross-section optical fiber 60 forming an output section 46. In this embodiment, it can be practical to have an input section 50 having a smaller core than the output section 46 to minimize losses.

In the embodiments schematized in FIGS. 5B and 5C, the output section 46 of the optical fiber can be referred to as a light pipe having the matching aspect ratio.

When using fiber illuminator embodiments such as schematized in FIGS. 5A, 5B and 5C, the projector lens group 14 can have its focal plane 40 coupled to coincide with an outlet end tip of the optical fiber. The optical fiber end tip is thus magnified and projected on the scene in the far field according to the required field of illumination.

In an alternate embodiment schematized at FIG. 5D, the fiber illuminator can have an optical fiber 62 having a core other than rectangular, but being subjected to an opaque mask 64 having a rectangular aperture 66 of the matching aspect ratio, coupled at the focal plane 40 of the projector lens group 14. The mask thus imparts a rectangular shape to a formerly circular (or other) cross-sectioned light output 68, thereby forming a rectangular illumination area at the focal plane 40.

All the fiber illuminator embodiments described above can further include an optical relay or the like to offset the rectangular illumination area from the output tip or mask, for instance.

Embodiments of fiber illuminators such as described above can produce rectangular field of illuminations 24 in the far field such as shown in FIG. 4. It will be understood that the aspect ratio shown in FIG. 4 is a 4:3 horizontal:vertical aspect ratio, but alternate embodiments can have other aspect ratios, depending on the camera aspect ratio, such as 3:2, 16:9, 1.85:1 or 2.39:1 for instance. Further, it will be noted that camera sensors could be provided in other shapes than rectangular, in which case the shape of the light output can be adapted accordingly to match the shape of the camera sensor.

In most uses, the field of illumination can be precisely matched and aligned to the camera field of view. In other instances, the field of illumination can be adjusted to be smaller than the field of view to obtain a higher light density on a portion of the target to obtain a better signal to noise ratio in an sub-area of the image. Either way, the field of illumination is aligned with the field of view.

The optical design of the projector lens group 14 can be appropriately scaled for the projection sub-system (illuminator dimensions/projector focal length) to be matched with the reception channel (sensor dimensions/telescope focal length). For instance, the field of view (reception channel) of a system based on a sensor (H×V) of 10 mm×7.5 mm and a variable focal length of 1000 mm to 2000 mm telescope will produces images that correspond from 10×7.5 mrad to 5×3.75 mrad field of view. To illuminate the scene using a rectangular fiber of 200 um×150 um, the projector focal length will range from 20 mm to 40 mm for the field of illumination to match the field of view. The projector focal length can exceed 40 mm to obtain a smaller field of illumination than the smallest field of view.

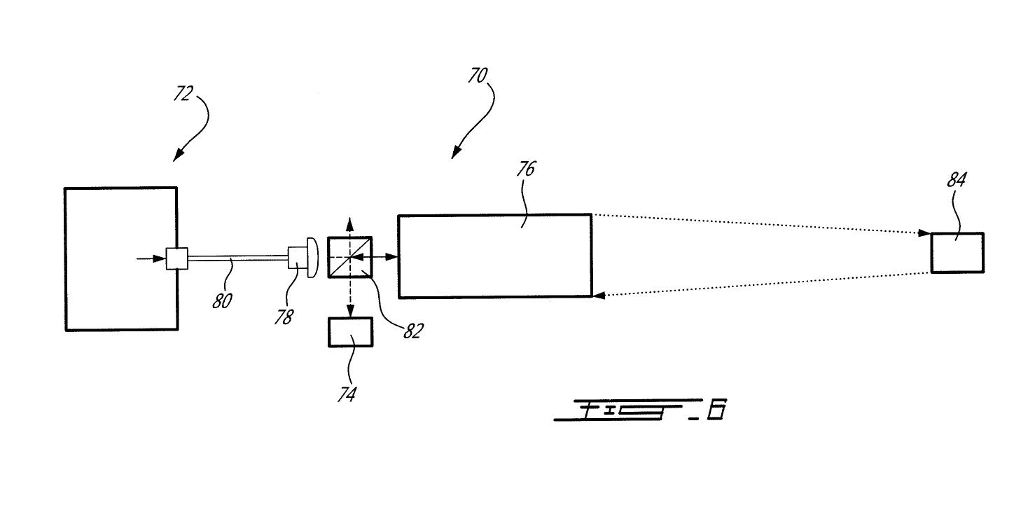

FIG. 6 shows an alternate embodiment of an active imaging device 70 having a field of view matching the field of illumination. In this embodiment, the fiber illuminator 72 and the sensor 74 share a common set of lens 76 which acts as both the projector lens group and a telescope lens group, i.e. the telescope is used as both the emission and the reception channel.

To achieve this, the illumination area can be scaled using an optical relay 78 between an optical fiber 80 and the focal plane to match the optical fiber physical dimension to the actual the sensor dimensions. A typical magnification of 10 would be required to scale a typical 1 mm fiber core to a 10 mm apparent size at the focal plane of the telescope. The magnified fiber image can then be injected in the telescope-projector 76 using a prism 82 or beamcombiner with a 50-50% transmission/reflection, for instance, in which case the emitter light is transmitted through the beamcombiner (or prism 82) with an transmission of 50% into the telescope up to the target 84 and the light coming back through the telescope 76, is reflected by the beamcombiner to the sensor 74 with again a reflection of 50%, for a global efficiency of 25%, which may nevertheless be sufficient for certain applications.

An active imaging device configuration such as shown above in relation to FIG. 3 can be used in a range gated imaging device for instance, where a precise flash of light can be sent to a distant target at the scene of observation, reflected, and the camera sensor gated to open and close as a function of the target range. Active imaging device configurations such as taught herein can also be used in any other application where it is convenient.

As can be understood, the examples described above and illustrated are intended to be exemplary only. The scope is indicated by the appended claims.

What is claimed is:

1. An active imaging device having: a fiber illuminator having a rectangular illumination area; a projector lens group having a focal plane coupleable to the rectangular illumination area to project a corresponding rectangular field of illumination on a scene located in the far field of the projector lens group, a camera having a camera sensor and a rectangular field of view alignable with the rectangular field of illumination, the field of view and the field of illumination having matching rectangular aspect ratios.

2. The active imaging device of claim 1 wherein the fiber illuminator has an optical fiber having an input end coupled to a light source and an output end.

3. The active imaging device of claim 2 wherein the output end has a rectangular core delimiting the rectangular illumination area at the output end thereof.

4. The active imaging device of claim 3 wherein the optical fiber is an integral rectangular core optical fiber.

5. The active imaging device of claim 3 wherein the optical fiber has an input section having a circular core and an output section having the rectangular core.

6. The active imaging device of claim 5 wherein the output section has a rectangular light pipe.

7. The active imaging device of claim 5 further comprising a fusion connection between the output section and the input section.

8. The active imaging device of claim 2 wherein the output end is coupled to a mask having a rectangular aperture delimiting the rectangular illumination area.

9. The active imaging device of claim 2 wherein the optical fiber is multi mode and delivers uniform intensity across the rectangular illumination area.

10. The active imaging device of claim 2 wherein the light source is one of a laser source and a LED source.

11. The active imaging device of claim 1 wherein camera sensor is coupled to a telescope lens group.

12. The active imaging device of claim 1 wherein the camera sensor is coupled to the projector lens group.

13. The active imaging device of claim 1 wherein the fiber illuminator is operable in pulse mode and the camera sensor is range gated.

14. The active imaging device of claim 1 wherein the fiber illuminator is operable in continuous mode.

15. The active imaging device of claim 1 wherein the camera, fiber illuminator, and projector lens group are mounted to a common frame of the active imaging device.

16. An active imaging device having: a frame; a camera mounted to the frame, having a camera sensor, and a field of view having a camera aspect ratio; a fiber illuminator mounted to the frame and having a rectangular cross-section light output path corresponding to the camera aspect ratio; and a projector lens group mounted to the frame, the projector lens group being optically coupleable to the light output path of the fiber illuminator for projection into a field of illumination aligned with the field of view of the camera.

17. The active imaging device of claim 16 wherein the fiber illuminator has an optical fiber having an input end coupled to a light source and an output end and having a rectangular core delimiting the rectangular illumination area at the output end.

18. The active imaging device of claim 16 wherein the fiber illuminator has an optical fiber having an input end coupled to a light source and an output end coupled to a mask having a rectangular aperture delimiting the rectangular illumination area.

19. The active imaging device of claim 16 wherein the optical fiber is multi mode and delivers uniform intensity across the rectangular illumination area.

20. The active imaging device of claim 16 wherein camera sensor is coupled to a telescope lens group determining the field of view.
